(19) United States
(12) Patent Application Publication
(10) Pub. No.: US 2017/0328636 A1
(43) Pub. Date: Nov. 16, 2017

(54) METHOD AND APPARATUS FOR CONTROLLING A PRODUCTION PROCESS

(71) Applicants: David K. Luce, Splendora, TX (US); Crystal A. Parrott, Helotes, TX (US); Michael P. Rigney, San Antonio, TX (US)

(72) Inventors: David K. Luce, Splendora, TX (US); Crystal A. Parrott, Helotes, TX (US); Michael P. Rigney, San Antonio, TX (US)

(73) Assignee: Baker Hughes Incorporated, Houston, TX (US)

(21) Appl. No.: 15/153,298

(22) Filed: May 12, 2016

(51) Int. Cl. F27D 19/00; F27D 21/02; F27D 21/00

(52) U.S. Cl. CPC F27D 19/00; F27D 21/02; F27D 21/00; F27D 2019/0059; F27D 2021/026; F27D 2019/0003

(57) ABSTRACT

A method of controlling a production process includes illuminating a portion of a workpiece undergoing a production process with a light having a selected wavelength, processing a portion of the workpiece, capturing a digital image of the light reflecting from a surface of the workpiece with a digital camera, performing, with a processor, a specular reflectance analysis of the digital image, and adjusting a production process parameter based on the specular reflectance analysis.

### BACKGROUND

Various manufacturing and treatment processes are very skill dependent. Training an employee to become proficient in a particular process may take months. Training represents a significant investment of time, resources and capital. Once trained, a worker may seek employment elsewhere taking with them the skills learned. The loss of such an employee represents a reduction in processes efficiency as well as loss of invested resources and the need to invest further resources to train a replacement.

### SUMMARY

A method of controlling a production process includes illuminating a portion of a workpiece undergoing a production process with a light having a selected wavelength, processing a portion of the workpiece, capturing a digital image of the light reflecting from a surface of the workpiece with a digital camera, performing, with a processor, a specular reflectance analysis of the digital image, and adjusting a production process parameter based on the specular reflectance analysis.

An apparatus for controlling a production process includes a light source having a selected wavelength directable toward a workpiece, a digital camera directable toward the workpiece, a production tool operable on the workpiece, and a processor operatively coupled to the digital camera and the production tool. The processor includes a specular reflectance analysis module and is operable to adjust a production process parameter based on a specular reflectance analysis of light passing from the light source reflecting from a portion of the workpiece.

### BRIEF DESCRIPTION OF THE DRAWINGS

Referring now to the drawings wherein like elements are numbered alike in the several Figures:

FIG. 1 is a block diagram depicting a production process system in accordance with an aspect of an exemplary embodiment;

FIG. 2 is a block diagram depicting a processor operatively associated with the production process of FIG. 1, in accordance with an aspect of an exemplary embodiment; and

FIG. 3 is a flow chart illustrating a method of processing a workpiece, in accordance with an aspect of an exemplary embodiment.

### DETAILED DESCRIPTION

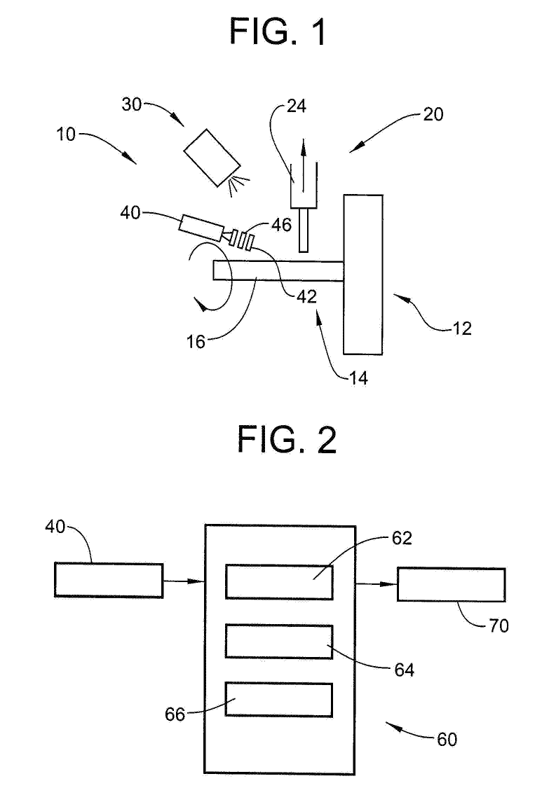

A production process system, in accordance with an aspect of an exemplary embodiment, is indicated generally at 10 in FIG. 1. Production processing system 10 may include a support 12 that retains a workpiece 14 for a production process. Workpiece 14 may take the form of a metallic workpiece or rotor 16. The production process may take the form of light intensive process such as welding and/or a thermal fusion coating process. A processing tool 20, which may take the form of a thermal treatment device 24 may heat workpiece 14 and/or a coating material (not shown) to a desired temperature, e.g., to a liquidus state. For example, thermal treatment device may form a molten metal portion of the coating material. As will be detailed more fully below, the coating material may take on a variety of forms and is substantially metallurgically bonded to workpiece 14 to enhance, for example, strength properties, chemical resistance properties and the like. The coating material may be deposited onto workpiece 14 through a variety of methods including a low velocity oxygen fueled (LVOF) spray, flame spray, high velocity oxygen fueled (HVOF) spray, plasma arc spray, sputtering, adhesive bonding, a matrix of organic material with metallic powder that is sprayed or layered onto the workpiece cured and fused, and laser clad (Powder Fed Laser) spray techniques.

In accordance with an aspect of an exemplary embodiment, production process system 10 includes a light source 30 having a selected wavelength directed at workpiece 14 and processing or production tool 20. Light source 30 may include one or more light emitting elements (not shown) that produced the selected wavelength. At this point, it should be understood that the term “wavelength” may include a bandwidth having a desired center wavelength. In accordance with an aspect of an exemplary embodiment, light source 30 includes a light output wavelength of about 470 nm. The wavelength of light source 30 may be selected depending on process conditions, materials and the like. Blue light having a wavelength of about 470 nm may be selected given differences that exist when compared to illumination generated by light intensive processes. A torch, for example, may emit a broadband illumination and a heated workpiece may emit a red light. The desired wavelength is selected such that reflected light constitutes a relatively greater portion of light from light source 30 and a relatively less portion of light generated by the process.

Production process system 10 further includes one or more digital cameras one of which is indicated at 40 directed toward workpiece 14. Digital camera 40 may take the forms of a complementary metal oxide semiconductor (CMOS) camera, a charged coupled device (CCD) camera or other form of camera that can capture a digital image of an object. Depending on the particular process, digital camera 40 may be protected with a shield 42. If the particular process employs heat, shield 42 may take the form of a heat shield. It should be understood that an additional shield (not shown) may be employed to protect light source 30.

In addition, digital camera 40 may be provided with a filter 46 that may be selected to restrict a broadband spectrum captured when directed toward workpiece 14 to a narrow band similar to that provided by light source 30. In accordance with an aspect of an exemplary embodiment, with light source 30 having a wavelength of about 470 nm, filter 46, may have a useful range of between about 425 nm and about 495 nm, and a full width at half maximum (FWHM) of about 85 nm.

In further accordance with an aspect of an exemplary embodiment illustrated in FIG. 2, production process system 10 includes a processor 60 that is operatively connected to digital camera 40. Processor 60 includes a central processing unit (CPU) 62, a non-volatile memory 64 and a specular reflectance analysis module 66. Specular reflectance analysis module 66 performs a specular reference analysis of images processed through digital camera 40. More specifically, light passing from light source 30 reflects off of workpiece 14. Depending on a quality of the reflected light, a determination is made whether the surface and/or the coating has reached a liquidus point/stage.

In accordance with an aspect of an exemplary embodiment, digital camera 40 captures images of workpiece 14 during processing by processing tool 20. Digital camera 40 also captures the light reflecting from workpiece 14. Specular reflectance analysis module 66 processes the images to determine a particular quality of the workpiece by detecting a specular as opposed to a diffuse character of the light reflected from workpiece 14. For example, during a coating process, specular reflectance analysis module 66 determines when a surface (not separately labeled) and/or the coating reach the liquidus stage.

At the liquidus stage, the surface reflectance characteristic changes from that if a diffuse reflector (a matt surface) to that of a specular reflector (a mirror-like surface). A diffuse surface will produce a substantially uniform image intensity regardless of surface orientation. The diffuse surface also includes a high surface roughness. Conversely, a specular surface is smooth, e.g., possesses little to no texture and produces a mirror like reflection. A specular surface will produce a highly variable image intensity dependent on the surface orientation and the relative positions of the camera and light source(s).

Once the liquidus stage is reached, it may be desirable to adjust a production process parameter. For example, once the liquidus stage is achieved, production tool 20 may be advanced, rotor 16 may be advanced, and/or a distance between rotor 16 and production tool 20 may be adjusted through manipulation of an adjustment mechanism 70. Other adjustments could include adjusting process temperatures, process speeds, workpiece rotational speeds, and the like.

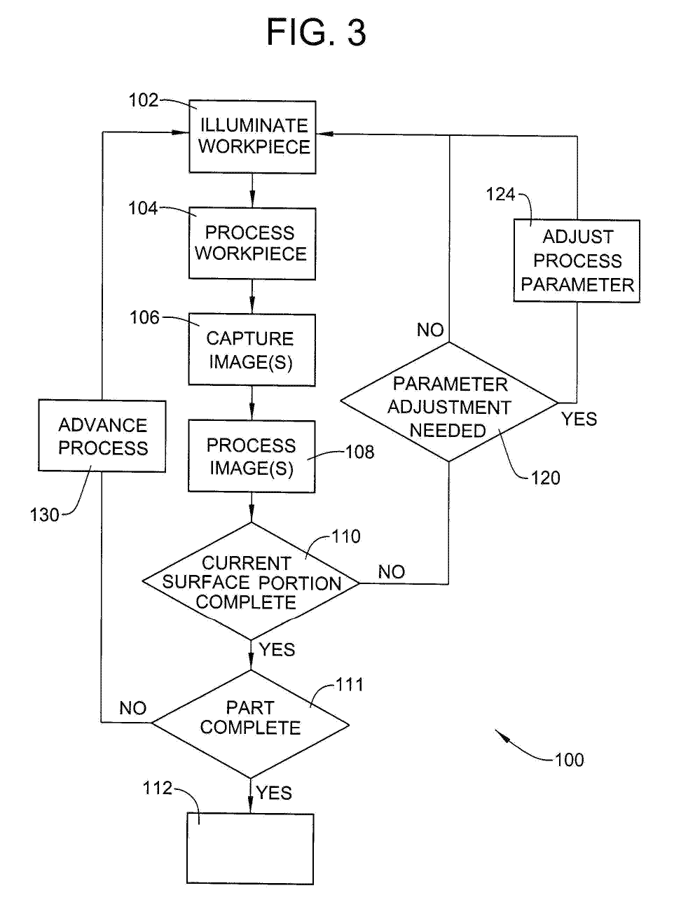

Reference will now follow to FIG. 3 in describing a method 100 of processing workpiece 14 secured in, for example a tailstock or other fixture that promotes a desired retention and manipulation. In block 102, light source 30 is activated to illuminate workpiece 14 with narrow band illumination. In block 104 processing begins. In accordance with an aspect of an exemplary embodiment, processing may include fusion bonding a coating to workpiece 14. In fusion bonding, a coating material is fused into a substantially homogenous coating that results in a combination of mechanical and metallurgical bond to workpiece 14. Of course other processes that involve heating a workpiece and/or a coating or bonding material may be employed. Thermal treatment device 24 heats a portion of workpiece 14 and/or the coating material (not separately labeled) to a desired temperature so as to reach the liquidus point.

In accordance with an aspect of an exemplary embodiment, the coating material may include one or more of NiCr alloys, Metal Matrix composites both with and without particles having higher melting points that yield significantly higher hardness and or toughness (wear surfacing), non-metal or mixtures of ceramics with metal. Coating materials may also be added during the molten phase when specular reflectance analysis module 66 determines a desired time to add metallic, non-metallic and/or organic material to achieve a desired surface characteristic. For example, adding silica, ceramic, carbides, or metals with higher melting points to create a metal matrix composite.

In block 106, an image(s) is captured of light reflecting off of the portion of workpiece 14 being processed. In accordance with an aspect of an exemplary embodiment, when workpiece undergoes a light intensive process, such as welding, oxy/acetylene, plasma arc, laser, gas tungsten arc welding and other light intense heating processes, the image quality for purpose of process control may be enhanced through the use of filter 46 at digital camera 40. Imaging with a narrow band filter that may be matched to a wavelength of light source 30 increases a sensor system to noise ratio. More specifically, filter 46 is selected to reject (or attenuates) illumination from light intensive processes and ambient illumination while allowing illumination from light source 30 reflected off of workpiece 14 to reach digital camera 40. High intensity process control illumination further increases the sensor system to noise ratio thereby enhancing process control reliability. In the present case, blue light emitted by light source 30 may enhance specular reflectance analysis of workpiece 14 during light intensive processing operations. In block 108, specular reflectance analysis module 66 processes the captured image(s) to determine if the liquidus point has been reached.

In block 110, a determination is made whether the portion of workpiece 14 being processed is completed by analyzing images of the processed portions to determine whether or not to cease, alter, or continue processing. If so, a determination is made in block 11 whether processing of workpiece 14 is complete. If workpiece 14 is complete, the process ends in block 112. If the portion of workpiece 14 is unfinished, a determination is made whether an adjustment to a production process parameter may advance processing in block 120. Production process parameter adjustments, as indicated above, may include advancing thermal treatment device 24, advancing workpiece 14, adjusting a distance between production tool 20 and workpiece 14, adjusting a rotational speed of workpiece 14 and the like through manipulation of adjustment mechanism 70. If an adjustment is indicated, and the liquidus point has been reached, a process parameter may be adjusted in block 124. For example, changes in temperature, speed or the like may aid in advancing the process. After adjustments are made, the process returns to block 102. If in block 120 adjustments are not needed, processing continues to block 102.

Further, if in block 111 a determination is made that workpiece 14 has not finished processing, the process may advance to a subsequent portion of workpiece 14 to be processed in block 130 and processing returns to block 102. For example, adjustment mechanism 70 may advance thermal treatment device 24 by, for example, rotating workpiece 14. In this manner, the coating may diffuse into workpiece 14 forming a fusion bond. By controlling a rate of advancement through adjustment mechanism 70, production processes system 10 may achieve a high quality bond having a desired specular appearance and bond strength.

At this point, it should be understood that while described in terms of a fusion coating process, the production processing system of the exemplary aspects may be employed in any processing system in which specular reflectance analysis of reflected light may be employed to determine process progress. The spectral analysis may then be employed to control a processing step, tool, or the like.

Embodiment 1. A method of controlling a production process comprising:

illuminating a portion of a workpiece undergoing a production process with a light having a selected wavelength;

processing a portion of the workpiece;

capturing a digital image of the light reflecting from a surface of the workpiece with a digital camera;

performing, with a processor, a specular reflectance analysis of the digital image; and

adjusting a production process parameter based on the specular reflectance analysis.

Embodiment 2. The method of any prior embodiment, wherein illuminating the portion of the workpiece includes illuminating a portion of a metallic workpiece undergoing one of a coating, cladding, fusing, sintering, and sputtering process.

Embodiment 3. The method of any prior embodiment, wherein processing the portion of the workpiece includes applying heat to a coating material applied to the portion of the workpiece with a thermal treatment device.

Embodiment 4. The method of any prior embodiment, further comprising: identifying portions of the surface which have transitioned to a liquidus point of the coating material based on the specular reflectance analysis.

Embodiment 5. The method of any prior embodiment, further comprising: shielding the digital camera from heat associated with the one of a coating, cladding, fusing, sintering, and sputtering process.

Embodiment 6. The method of any prior embodiment, further comprising: filtering light passing to the digital camera with a narrow band filter.

Embodiment 7. The method of any prior embodiment, wherein illuminating the portion of a workpiece includes illuminating the portion of the workpiece with a narrow band illumination that substantially passes through the narrow band filter.

Embodiment 8. The method of any prior embodiment, wherein adjusting the production process parameter includes adjusting one of a speed of the workpiece, a speed of a production tool, and a distance between the workpiece and the production tool and a relative position of the production tool and the workpiece.

Embodiment 9. An apparatus for controlling a production process comprising:

a light source having a selected wavelength directable toward a workpiece;

a digital camera directable toward the workpiece;

a production tool operable on the workpiece; and

a processor operatively coupled to the digital camera and the production tool, the processor including a specular reflectance analysis module and being operable to adjust a production process parameter based on a specular reflectance analysis of light passing from the light source reflecting from a portion of the workpiece.

Embodiment 10. The apparatus according to any prior embodiment, further comprising: a narrow band filter arranged at the digital camera, the narrow band filter having a wavelength that substantially passes the wavelength of the light source.

Embodiment 11. The apparatus according to any prior embodiment, wherein the light source includes a wavelength of about 470 nm and the narrow band filter includes a wavelength of between about 425 nm and about 495 nm, and a full width at half maximum (FWHM) of about 85 nm.

Embodiment 12. The apparatus according to any prior embodiment, wherein the production tool is operable to perform a thermal treatment process to the workpiece.

Embodiment 13. The apparatus according to any prior embodiment, wherein the processor is operable to determine which portions of the workpiece transitioned past a liquidus point of the thermal treatment process based on the specular reflectance analysis.

Embodiment 14. The apparatus according to any prior embodiment, wherein the production tool comprises a thermal treatment device.

Embodiment 15. The apparatus according to any prior embodiment, wherein the thermal treatment device is operable to form a molten metal portion of the coating.

The term “about” is intended to include the degree of error associated with measurement of the particular quantity based upon the equipment available at the time of filing the application. For example, “about” can include a range of ±8% or 5%, or 2% of a given value.

While one or more embodiments have been shown and described, modifications and substitutions may be made thereto without departing from the spirit and scope of the invention. Accordingly, it is to be understood that the present invention has been described by way of illustrations and not limitation.

What is claimed is:

1. A method of controlling a production process comprising:
illuminating a portion of a workpiece undergoing a production process with a light having a selected wavelength;
processing a portion of the workpiece;
capturing a digital image of the light reflecting from a surface of the workpiece with a digital camera;
performing, with a processor, a specular reflectance analysis of the digital image; and
adjusting a production process parameter based on the specular reflectance analysis.

2. The method of claim 1, wherein illuminating the portion of the workpiece includes illuminating a portion of a metallic workpiece undergoing one of a coating, cladding, fusing, sintering, and sputtering process.

3. The method of claim 2, wherein processing the portion of the workpiece includes applying heat to a coating material applied to the portion of the workpiece with a thermal treatment device.

4. The method of claim 3, further comprising: identifying portions of the surface which have transitioned to a liquidus point of the coating material based on the specular reflectance analysis.

5. The method of claim 2, further comprising: shielding the digital camera from heat associated with the one of a coating, cladding, fusing, sintering, and sputtering process.

6. The method of claim 1, further comprising: filtering light passing to the digital camera with a narrow band filter.

7. The method of claim 6, wherein illuminating the portion of a workpiece includes illuminating the portion of the workpiece with a narrow band illumination that substantially passes through the narrow band filter.

8. The method of claim 1, wherein adjusting the production process parameter includes adjusting one of a speed of the workpiece, a speed of a production tool, and a distance between the workpiece and the production tool and a relative position of the production tool and the workpiece.

9. An apparatus for controlling a production process comprising:
a light source having a selected wavelength directable toward a workpiece;
a digital camera directable toward the workpiece;
a production tool operable on the workpiece; and
a processor operatively coupled to the digital camera and the production tool, the processor including a specular reflectance analysis module and being operable to adjust a production process parameter based on a specular reflectance analysis of light passing from the light source reflecting from a portion of the workpiece.

10. The apparatus according to claim 9, further comprising: a narrow band filter arranged at the digital camera, the narrow band filter having a wavelength that substantially passes the wavelength of the light source.

11. The apparatus according to claim 10, wherein the light source includes a wavelength of about 470 nm and the narrow band filter includes a wavelength of between about 425 nm and about 495 nm, and a full width at half maximum (FWHM) of about 85 nm.

12. The apparatus according to claim 9, wherein the production tool is operable to perform a thermal treatment process to the workpiece.

13. The apparatus according to claim 12, wherein the processor is operable to determine which portions of the workpiece transitioned past a liquidus point of the thermal treatment process based on the specular reflectance analysis.

14. The apparatus according to claim 9, wherein the production tool comprises a thermal treatment device.

15. The apparatus according to claim 14, wherein the thermal treatment device is operable to form a molten metal portion of the coating.
